(19) United States
(12) Patent Application Publication
(10) Pub. No.: US 2014/0202170 A1
(43) Pub. Date: Jul. 24, 2014

(54) Composite Articles and Methods

(71) Applicant: United Technologies Corporation, (US)

(72) Inventor: Grant O. Cook, III, Tolland, CT (US)

(73) Assignee: United Technologies Corporation, Hartford, CT (US)

(21) Appl. No.: 13/682,048

(22) Filed: Nov. 20, 2012

(51) Int. Cl. F02C 7/04

(52) U.S. Cl. CPC F02C 7/04
USPC 60/805; 205/196; 428/332; 428/215; 138/109; 427/404

(57) ABSTRACT

An article has a polymeric substrate and a coating system. The coating system includes a metallic plating and a polymeric coating atop the metallic plating. The metallic plating has a thickness of at least 0.05 mm.

### BACKGROUND

The disclosure relates to gas turbine engines. More particularly, the disclosure relates to fluid ducts.

In an exemplary gas turbine engine, ducting can be fabricated using a variety of processes, such as a composite layup or forming a sheet metal to the desired shape using a combination of cutting, bending, welding, and/or stamping processes. US8273430B2 discloses an alternative in which ducting is formed of a metallic inner layer and a polymeric outer layer by a stamping process.

### SUMMARY

One aspect of the disclosure involves an article having a polymeric substrate and a coating system. The coating system includes a metallic plating and a polymeric coating atop the metallic plating. The metallic plating has a thickness of at least 0.05 mm.

In further embodiments of any of the foregoing embodiments: the coating system comprises the polymeric coating atop the metallic plating along a majority of an interior surface area; and along a majority of an exterior surface area, the coating system comprises the metallic plating without the polymeric coating.

In further embodiments of any of the foregoing embodiments, the matrix is a thermoplastic material forming a majority of the substrate by weight.

In further embodiments of any of the foregoing embodiments, the substrate comprises polyetherimide, thermoplastic polyimide, or polyether ether ketone (PEEK).

In further embodiments of any of the foregoing embodiments: the substrate comprises polyetherimide or thermoplastic polyimide; and the polymeric coating comprises PEEK.

In further embodiments of any of the foregoing embodiments, the substrate has a thickness of 1.27-6.35 mm.

In further embodiments of any of the foregoing embodiments, the metallic plating forms at least 30% by weight of the article.

In further embodiments of any of the foregoing embodiments, the metallic plating comprises nickel as a largest by-weight content.

In further embodiments of any of the foregoing embodiments, the metallic plating has a thickness of at least 0.25 mm.

In further embodiments of any of the foregoing embodiments, the metallic plating imparts the principal strength of the article.

In further embodiments of any of the foregoing embodiments, the polymeric coating comprises PEEK.

In further embodiments of any of the foregoing embodiments, the polymeric coating has a thickness of 0.5-2.0 mm.

In further embodiments of any of the foregoing embodiments, the article is a turbine engine duct having: a first flange having an opening; a second flange having an opening; and a conduit connecting the openings.

In further embodiments of any of the foregoing embodiments, the turbine engine duct is at least one of: an air oil cooler inlet duct; an air oil cooler outlet duct; a precooler inlet duct; and an active clearance control inlet duct.

In further embodiments of any of the foregoing embodiments, a gas turbine engine has: a compressor section; a combustor downstream of the compressor section along a core flowpath; a turbine section downstream of the combustor along the core flowpath and coupled to the compressor section to drive the compressor section and the article as an air duct.

In further embodiments of any of the foregoing embodiments, a method for manufacturing the article comprises: molding the substrate; plating the molded substrate to form the metallic plating; and applying the polymeric coating to the metallic plating.

In further embodiments of any of the foregoing embodiments, the applying comprises spraying.

In further embodiments of any of the foregoing embodiments, the plating is electroless plating, electrolytic plating, or electroforming.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic axial sectional view of a gas turbine engine.

FIG. 2 is a partially schematic left side view of the engine with aerodynamic structures removed.

FIG. 3 is a partially schematic right side view of the engine with aerodynamic structures removed.

FIG. 4 is a view of a first duct of the engine of FIG. 1.

FIG. 5 is a cross-sectional view of the duct of FIG. 4.

FIG. 6 is a view of a second duct.

FIG. 7 is a view of a third duct.

FIG. 8 is a view of a fourth duct.

Like reference numbers and designations in the various drawings indicate like elements.

### DETAILED DESCRIPTION

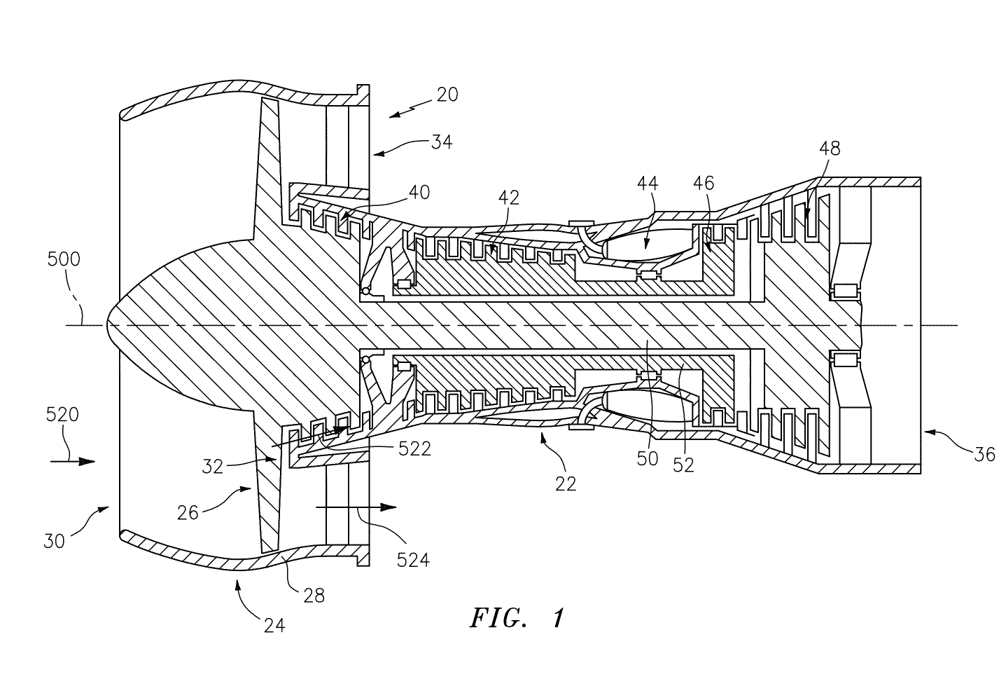

FIG. 1 shows a gas turbine engine 20 having an engine case 22 surrounding a centerline or central longitudinal axis 500. An exemplary gas turbine engine is a turbofan engine having a fan section 24 including a fan 26 within a fan case 28. The exemplary engine includes an inlet 30 at an upstream end of the fan case receiving an inlet flow along an inlet flowpath 520. The fan 26 has one or more stages of fan blades 32. Downstream of the fan blades, the flowpath 520 splits into an inboard portion 522 being a core flowpath and passing through a core of the engine and an outboard portion 524 being a bypass flowpath exiting an outlet 34 of the fan case.

The core flowpath 522 proceeds downstream to an engine outlet 36 through one or more compressor sections, a combustor, and one or more turbine sections. The exemplary engine has two axial compressor sections and two axial turbine sections, although other configurations are equally applicable. From upstream to downstream there is a low pressure compressor section (LPC) 40, a high pressure compressor section (HPC) 42, a combustor section 44, a high pressure turbine section (HPT) 46, and a low pressure turbine section (LPT) 48. Each of the LPC, HPC, HPT, and LPT comprises one or more stages of blades which may be interspersed with one or more stages of stator vanes.

In the exemplary engine, the blade stages of the LPC and LPT are part of a low pressure spool mounted for rotation about the axis 500. The exemplary low pressure spool includes a shaft (low pressure shaft) 50 which couples the blade stages of the LPT to those of the LPC and allows the LPT to drive rotation of the LPC. In the exemplary engine, the shaft 50 also directly drives the fan. In alternative implementations, the fan may be driven via a transmission (e.g., a fan gear drive system such as an epicyclic transmission between the fan and the low pressure spool) to allow the fan to rotate at a lower speed than the low pressure shaft. Also, although shown as an axial two-spool engine, other spool counts and configurations may be used.

The exemplary engine further includes a high pressure shaft 52 mounted for rotation about the axis 500 and coupling the blade stages of the HPT to those of the HPC to allow the HPT to drive rotation of the HPC. In the combustor 44, fuel is introduced to compressed air from the HPC and combusted to produce a high pressure gas which, in turn, is expanded in the turbine sections to extract energy and drive rotation of the respective turbine sections and their associated compressor sections (to provide the compressed air to the combustor) and fan.

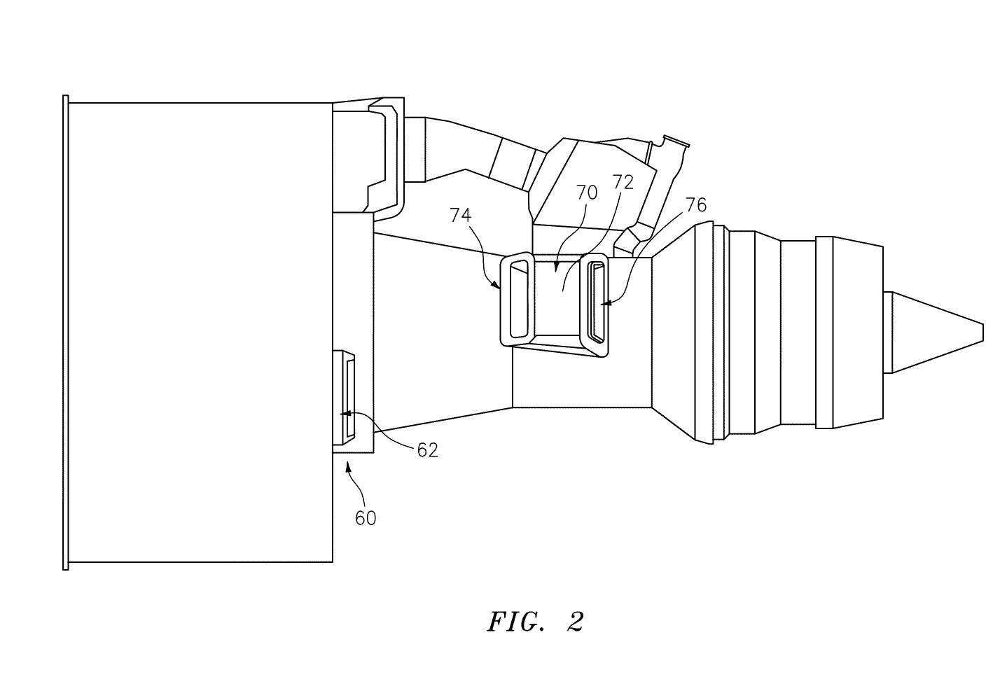

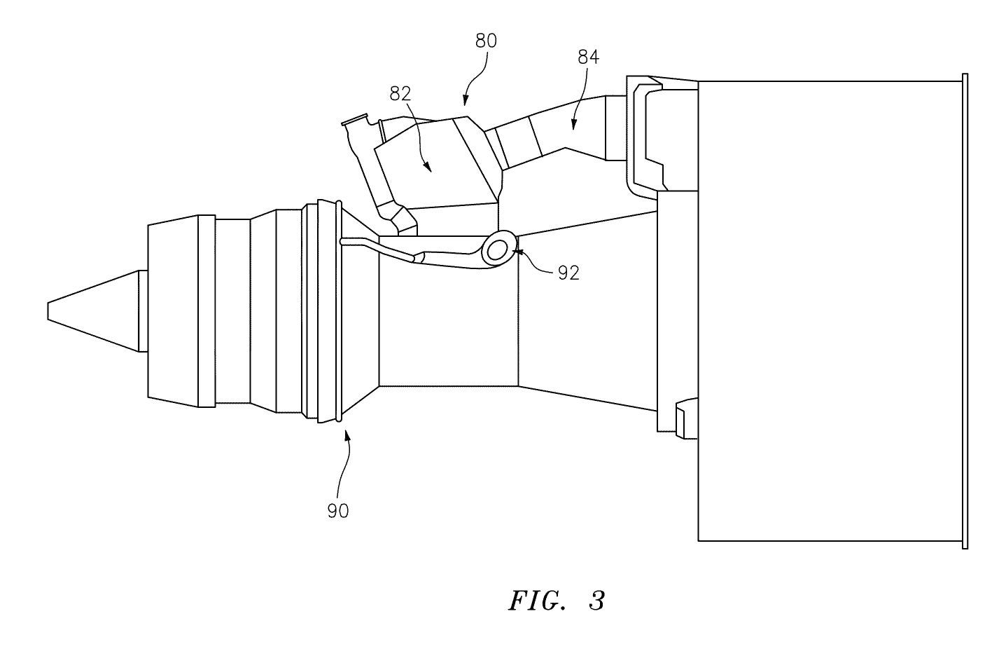

FIGS. 2 and 3 are, respectively, left and right side views of the engine with aerodynamic exterior surface panels removed. FIGS. 2 and 3 show various components of systems which may be made according to the present disclosure. The exemplary systems include a variable frequency generator (VFG) system 60 which includes a combined inlet fairing and flow guide 62. The variable frequency generator (VFG) is an electrical power generator powered by an input shaft that is driven by the main engine (e.g., its gearbox). This generator creates heat and is cooled by flowing oil though a pair of heat exchangers. These heat exchangers have air directed into them by the VFG heat exchanger (HEX) inlet fairing, which is in the bypass (fan air) flow path acting as a scoop. The heat exchanger may be partially enclosed by the fairing.

FIG. 2 further includes an air-oil cooler (AOC) system 70 including an air-oil heat exchanger unit 72. An air inlet duct (AOC inlet duct) 74 guides air to the heat exchanger 72 and an air outlet duct (AOC exhaust duct) 76 guides air from the heat exchanger. The air-oil cooler system serves to cool engine oil via a diversion of bypass air. As is discussed further below, either of the ducts 74 and 76 may reflect a baseline metallic or composite duct replaced by a new duct.

FIG. 3 further includes a precooler system 80. The precooler system includes a heat exchanger unit 82 used to cool a compressor bleed air stream by a diversion of the bypass flow. A precooler inlet duct 84 guides the bypass flow diversion to the heat exchanger. The precooler and the duct 84 may reflect a baseline metallic or composite component replaced by a novel component.

FIG. 3 further shows a turbine section active clearance control (ACC) system 90 which also draws a portion of bypass air to pneumatically actuate blade outer air seal segments to control clearance. The ACC system 90 includes an inlet duct 92. The inlet duct 92 may represent a baseline metallic or composite article replaced by a novel article.

FIGS. 4-8 show various of the aforementioned articles. The exemplary articles are gas turbine engine components. An exemplary component genus is an air duct for a gas turbine engine. The exemplary article comprises a polymeric substrate and a metallic layer and replaces a metallic (e.g., formed sheet metal) or composite layup baseline part.

FIG. 4 shows the AOC inlet duct 74. The exemplary duct 74 extends from an inlet end 120 formed at a flange 122 to an outlet end 124 formed at a flange 126.

The duct 74 includes a sidewall 128 extending between the flanges 122 and 126 and cooperating therewith to define respective inlet and outlet ports 130 and 132.

Each of the exemplary flanges 122 and 126 has a front (mounting) face 134, 136 and a rear face 138, 140.

One or both of the exemplary flanges may include mounting holes 142. Additionally, the duct may include ports and/or integral fittings (of which an exemplary integral fitting 144 is shown) and/or further mounting features.

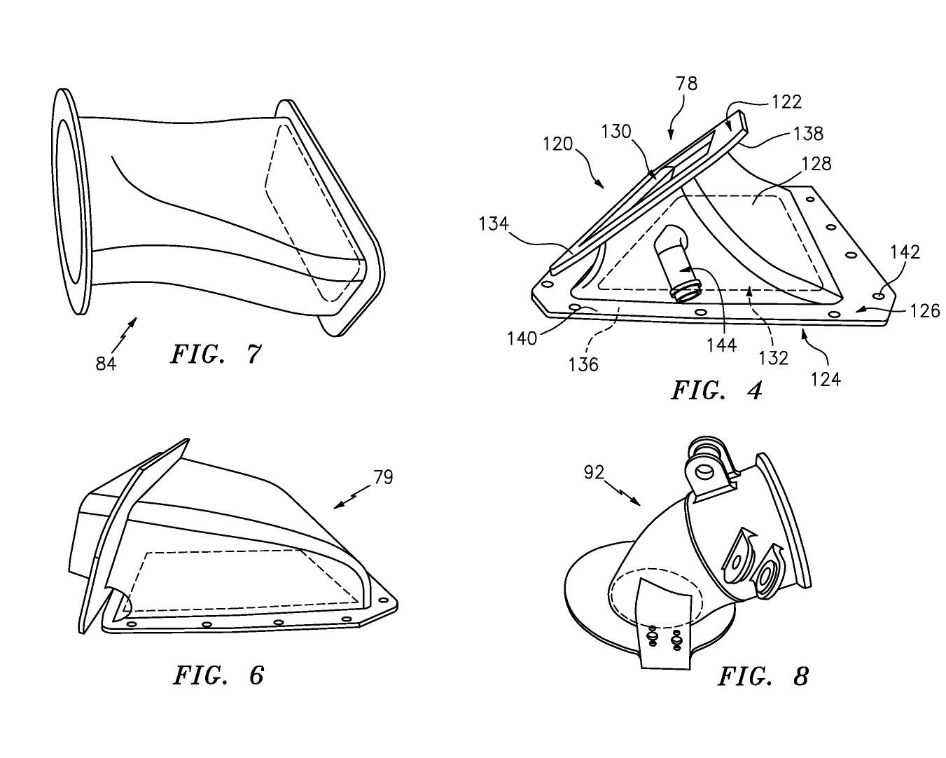

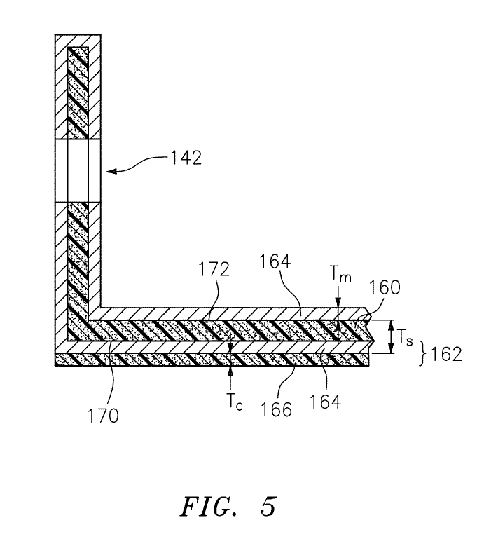

The article comprises a substrate 160 and a coating 162 (FIG. 5). The coating may include one or more layers. The layers include at least a metallic layer 164. One or more functional layers atop the metal layer may be of appropriate materials for functions such as wear resistance, heat resistance, environmental protection (e.g., chemical resistance), and the like. The one or more additional layers includes a polymeric layer 166. The exemplary substrate has a local sidewall structure having a first surface 170 and a second surface 172. The exemplary two-layer coating is on the first surface but not the second. The exemplary first surface forms an interior surface along the fluid flowpath (air flowpath) through the duct. The exemplary sidewall may be the sidewall of the AOC inlet duct or other article discussed above. In this implementation, the exterior surface includes only the metallic layer 164. In this particular implementation, the metallic layer 164 covers substantially the entirety of the exterior of the substrate (e.g., perhaps omitting small features such as the inner diameter (ID) of mounting holes if the holes are machined after applying the metallic layer). In this particular implementation, the metallic layer is left exposed along the exterior of the duct when assembled to its associated components so as to present a flame-resistant exterior surface. Additionally, the exemplary metal area is exposed along the forward (mounting) face of the flange so as to provide precise mounting. However, alternative implementations might include the polymeric layer along the flange mounting face and further alternative implementations might include the polymer layer 166 along all or a portion of the exterior. As is discussed further below, the polymer coating 166 may impart damage resistance.

The exemplary substrate is an injection-molded or compression-molded piece formed of: at least one of polyetherimide (e.g., trademark ULTEM of SABIC Innovative Plastics Holding BV, Pittsfield, Mass.); thermoplastic polyimide (e.g., trademark EXTEM of SABIC Innovative Plastics Holding BV, Pittsfield, Mass.; polyether ether ketone (PEEK); or any of the foregoing with fiber reinforcement e.g., carbon fiber or glass-fiber). An exemplary substrate comprises a single one of the forgoing as a by-weight majority (more particularly as just a single material and not in a block co-polymer).

In a particular example of an AOC inlet duct, or other embodiment, an initial precursor is molded by injection (or compression) molding using RTP 2185, a carbon-fiber-reinforced grade of ULTEM polyetherimide. The mold will include at least two retractable (or removable) inserts to achieve the desired angled internal flow path and mounting features (additionally or alternatively, some such features (e.g., flanges or bosses) may be bonded on using a suitable adhesive after molding but before plating to simplify the mold tooling). Holes for attachment (e.g., by bolt, rivets, etc.) are machined in the molded part (unless they were included in the mold tooling; however, there might be finish machining of molded holes or other features). It is preferable that no mold release, or comparable chemical agents, be used during the molding process to facilitate a strong bond between the plating and polymer (however, in certain instances, depending on mold release formulation and/or part requirements, a mold release could be used and/or a cleaning process may remove mold release residue).

Exemplary substrate thickness Tₛ is 0.05-0.2 inch (1.3-5 mm, more particularly 2.0-4.0 mm). The thickness may be a local thickness or a thickness over a majority of a surface area of the substrate or as a mean, median or modal value over the substrate. The substrate may be formed with various flanges, ribs, gussets, bosses and the like. These may cause substantial local departures in substrate thickness, coating gaps, etc.

The exemplary metallic layer 164 provides fire protection and imparts the principal strength of the article (as indicated by mechanical test results of representative test specimens or part cut-ups as compared to mechanical test results of the polymeric part with no or little plating). The exemplary metallic layer 164 also forms at least 30% by weight of the article, more particularly 40%-80% or 55%-70%.

Exemplary metal is nickel or by-weight majority nickel with an ultimate tensile strength of at least 60 ksi (414 MPa). Exemplary metal is applied by electroless plating, electroplating or electroforming (specifications for electroforming are sometimes more applicable to thick platings than electroplating specifications are) to a thickness T_{M} of 2-50 thousandths of an inch (0.05-1.3 mm, more narrowly 0.25-1.0 mm, or alternatively at least 0.25 mm yet thinner than the substrate while still at least 0.05 mm, or alternatively, at least 0.20 mm). The thickness may be a local thickness or a thickness over a majority of a surface area (either of the substrate as a whole or of the plated portion of the substrate) or as a mean, median or modal value over the substrate as a whole or a plated portion thereof.

The molded precursor can be masked to provide localized areas that are unplated (e.g., that are not conductive, can be bonded using adhesives that are well-suited for polymers, and/or allow for outgassing of the polymer during high-temperature excursions), if desired, although the amount of masking should be minimal (to maximize strength and structural integrity). The plating material is typically pure Ni or a hardened Ni applied from a Ni sulfamate solution. Other plating materials, such as Ni—P or Ni—Co, can be applied to achieve certain results. Also, different plating solutions, such as Ni sulfate, can be used to deposit the plating resulting in a different set of properties. A typical plating for this application would be a low-stressed Ni plating (per AMS 2424) or a hardened Ni plating (per AMS 2423) applied using a Ni sulfamate bath.

In the example, plating is applied to internal passages and holes in the part, provided they are sufficiently large for the plating solution to deposit material. If desired, holes can be machined into the plated polymer structure to accommodate attachment, etc. rather than incorporating holes in the mold or machining them before plating.

In the particular example or other embodiment, there may be a post-plating cleaning/washing to remove any plating solution.

The exemplary polymer coating 166 protects the metal against impact or foreign object damage and environmental corrosion. The outer polymer coating may provide the first line of defense against nicks, dents, and scratches, helping to prolong part life by delaying damage to the plating that can eventually lead to crack initiation and propagation.

The exemplary polymer coating 166 is a PEEK coating (e.g., trademark VICOTE of Victrex plc., Lancashire, GB).

The polymer coating may be applied by spraying (e.g., thermal spray or electrostatic or dispersion spray) to a thickness of T_{c} of 0.1-2.0 mm, more narrowly 0.25-1.0 mm. The thickness may be a local thickness or a thickness over a majority of a surface area (either of the substrate as a whole or of the plated and coated portion of the substrate) or as a mean, median or modal value over the substrate as a whole or a plated and coated portion thereof.

If desired, the part can be masked before spraying to apply the polymer coating only in areas of interest. For example, the portions of the duct ultimately exposed to an external environment may be masked to leave the ultimate duct with exposed metal exterior for fire-resistance (e.g., only the internal passage of the duct will be coated).

Relative to a pure metal article, the composite may be easier to manufacture. Complex shapes might require complex machining, stamping/bending, welding, or other steps. In contrast, a polymeric part may be easier to mold in a convoluted shape. In addition, the polymer-metal composite part has a lower weight than a metal part of the same size and geometry. Further, in many cases, injection molding and conventional plating processes have lower unit costs than composite layups or metal forming, welding, etc. Also, the process may allow for simple modular changes by using a different polymer in the molding process and/or a different plating bath setup to achieve a range of desired properties.

Relative to a pure polymeric article or an article with only a thin metal layer, the composite may be thinner, thereby providing greater use flexibility where a thicker structure would not fit. Also the metal may increase resistance to particular impact or foreign object damage (FOD). Furthermore, the thicker plating provides structure that is capable of significantly higher loads, in excess of those typical of injection-molded polymers in the flow direction (best-case property, not achieved throughout a molded part). The thicker plating is also capable of maintaining part geometry while under load during a fire.

The AOC exhaust duct 76 of FIG. 6 has a generally similar construction to the AOC inlet duct 74. A collar-like boss protrudes centrally from the forward (mounting) face of the outlet flange. In such a situation, the two-layer coating may extend fully around this boss on both its inner and outer surfaces.

The precooler inlet duct 84 of FIG. 7 may also be similarly formed to the AOC inlet duct. The exemplary duct 84 includes a rounded-corner rectangular inlet flange and a circular outlet flange and port.

The ACC inlet duct 92 of FIG. 8 has inlet and outlet flanges which lack mounting holes. The exemplary outlet flange may be engaged by a clamping structure. FIG. 8 further shows several mounting features unitarily formed with the remainder of the structure and including a pair of clevises and a bracket. The two-layer coating may extend along these mounting features as well.

One or more embodiments have been described. Nevertheless, it will be understood that various modifications may be made. For example, when implemented as a replacement for a baseline part, details of the baseline may influence details of any particular implementation. Accordingly, other embodiments are within the scope of the following claims.

What is claimed is:

1. An article comprising:
a polymeric substrate; and
a coating system comprising:
a metallic plating has a thickness of at least 0.05 mm; and
a polymeric coating atop the metallic plating.

2. The article of claim 1 wherein:
the coating system comprises the polymeric coating atop the metallic plating along a majority of an interior surface area; and
along a majority of an exterior surface area, the coating system comprises the metallic plating without the polymeric coating.

3. The article of claim 1 wherein:
the matrix is a thermoplastic material forming a majority of the substrate by weight.

4. The article of claim 1 wherein:
the substrate comprises polyetherimide, thermoplastic polyimide, or PEEK.

5. The article of claim 1 wherein:
the substrate comprises polyetherimide or thermoplastic polyimide; and
the polymeric coating comprises PEEK.

6. The article of claim 1 wherein:
the substrate has a thickness of 1.27-6.35 mm.

7. The article of claim 1 wherein:
the metallic plating forms at least 30% by weight of the article.

8. The article of claim 1 wherein:
the metallic plating comprises nickel as a largest by-weight content.

9. The article of claim 1 wherein:
the metallic plating thickness is at least 0.25 mm.

10. The article of claim 1 wherein:
the metallic plating imparts the principal strength of the article.

11. The article of claim 1 wherein:
the polymeric coating comprises PEEK.

12. The article of claim 1 wherein:
the polymeric coating has a thickness of 0.5-2.0 mm.

13. The article of claim 1 being a turbine engine duct having:
a first flange having an opening;
a second flange having an opening; and
a conduit connecting the openings.

14. The turbine engine duct of claim 13 being at least one of:
an air-oil cooler inlet duct;
an air-oil cooler outlet duct;
a precooler inlet duct; and
an active clearance control inlet duct.

15. A gas turbine engine having:
a compressor section;
a combustor downstream of the compressor section along a core flowpath; and
a turbine section downstream of the combustor along the core flowpath and coupled to the compressor section to drive the compressor section,
wherein the engine comprises the article of claim 1 as an air duct.

16. A method for manufacturing the article of claim 1, the method comprising:
molding the substrate;
plating the molded substrate to form the metallic plating; and
applying the polymeric coating to the metallic plating.

17. The method of claim 16 wherein:
the applying comprises spraying.

18. The method of claim 17 wherein:
the plating is electroless plating, electrolytic plating, or electroforming.
